(19) United States
(12) Patent Application Publication
(10) Pub. No.: US 2015/0244017 A1
(43) Pub. Date: Aug. 27, 2015

(54) ELECTRODE PLATE AND SECONDARY BATTERY

(71) Applicant: Sharp Kabushiki Kaisha, Osaka (JP)

(72) Inventors: Shumpei Nishinaka, Osaka (JP); Naoto Nishimura, Osaka (JP); Takahiro Matsuyama, Osaka (JP); Isao Asako, Osaka (JP); Motoaki Nishijima, Osaka (JP); Satoshi Arima, Osaka (JP); Hisayuki Utsumi, Osaka (JP)

(21) Appl. No.: 14/423,316

(22) PCT Filed: Aug. 28, 2013
(86) PCT No.: PCT/JP2013/072977

§ 371 Date: Feb. 23, 2015

(30) Foreign Application Priority Data
Aug. 29, 2012 (JP) 2012-188561

(51) Int. Cl. H01M 10/04; H01M 4/70; H01M 2/26

(52) U.S. Cl. CPC H01M 10/0413; H01M 2/26; H01M 4/70; H01M 2004/021

(57) ABSTRACT

In a secondary battery including a large-sized electrode group including stacked positive and negative electrode plates, an electrode plate in which failures such as the separation and cracking of an active material layer and the abrasion and cracking of a current collector are unlikely to occur is provided. An electrode plate 21 includes a coated region CR where active material layers 21a are formed and an uncoated region NC where no active material layer is formed and has a configuration in which a boundary section between the coated region and the uncoated region is provided with a first buffer region C2 having a non-linear irregular shape in plan view.

### TECHNICAL FIELD

The present invention relates to secondary batteries including a stacked electrode group including alternately stacked positive and negative electrode plates and particularly relates to an electrode plate suitable for constructing a large-sized secondary battery with a large two-dimensional size and a secondary battery including the electrode plate.

### BACKGROUND ART

In recent years, lithium secondary batteries have been used as power supply batteries for portable electronic devices such as mobile phones and notebook personal computers because the lithium secondary batteries have high energy density and enables downsizing and lightening. Furthermore, they have been attracting attention as power supplies for driving mortars for electric vehicles (EVs), hybrid electric vehicles (HEVs), and the like because high capacity can be achieved.

The lithium secondary batteries each include a cover case which makes up a battery can, which contains an electrode group in which positive electrode plates and negative electrode plates are placed opposite to each other with separators interposed therebetween, and which is filled with an electrolyte solution; a positive current collector terminal connected to a plurality of positive current collector tabs of the positive electrode plates; a positive external terminal electrically connected to the positive current collector terminal; a negative current collector terminal connected to a plurality of negative current collector tabs of the negative electrode plates; and a negative external terminal electrically connected to the negative current collector terminal.

A wound electrode group and a stacked electrode group are known. The wound electrode group has a configuration in which a positive electrode plate, a negative electrode plate, and a separator interposed therebetween are integrally wound. The stacked electrode group has a configuration in which a plurality of positive electrode plates and negative electrode plates are stacked with separators interposed therebetween.

A lithium secondary battery including a stacked electrode group has a configuration in which an electrode group including a plurality of stacked positive electrode plates, negative electrode plates, and separators interposed therebetween is placed in a cover case filled with a non-aqueous electrolyte solution. The lithium secondary battery is provided with a positive current collector terminal connected to a positive current collector tab of each positive electrode plate; a positive external terminal electrically connected to the positive current collector terminal; a negative current collector terminal connected to a negative current collector tab of each negative electrode plate; and a negative external terminal electrically connected to the negative current collector terminal.

In the case of preparing a stack type of high-capacity secondary battery, an increased number of stacked positive and negative electrode plates with an increased area and an increased amount of a filled electrolyte solution are often used. The thickness of a layer of an active material applied to each electrode plate tends to be large. The positive and negative electrode plates are manufactured in such a manner that, for example, an electrode mix paint containing a pasty positive electrode active material is applied to both surfaces of aluminium foil for forming current collectors of the positive electrode plates to a predetermined thickness and is dried and the aluminium foil is pressed with a roll press and is then cut into pieces with a predetermined size.

A region of the electrode plate that is connected to a current collector terminal is an uncoated region where no active material layer is formed. The following regions are present in the electrode plate: a coated region coated with the electrode mix paint and the uncoated region not coated with the electrode mix paint. That is, when the positive and negative electrode plates are manufactured, a boundary section between the coated region and the uncoated region is formed on a portion of each current collector.

Thus, when the thickness of the active material layer is large, the difference in level between the coated region and the uncoated region, that is, the difference in level of the boundary section is large and therefore a load is likely to be concentrated on the boundary section during a drying step or a pressing step to cause failures such as the separation and cracking of the active material layer and the abrasion and cracking of the current collector. That is, during drying, a load is caused by the contraction of the active material layer due to drying and, during pressing, a load is caused by the concentration of stress.

Therefore, a method for suppressing a failure due to such a boundary section is being investigated. An electrode plate for secondary batteries has been already proposed (refer to, for example, PTL 1). The electrode plate is configured such that the thickness of the boundary section is gradually reduced from a coated region toward an uncoated region. The raising of a beginning portion of the coated region is suppressed such that the breakage of the electrode plate or the separation of an active material layer due to stress concentration is prevented.

### CITATION LIST

### Patent Literature

PTL 1: Japanese Unexamined Patent Application Publication No. 2010-108678

### SUMMARY OF INVENTION

### Technical Problem

Even if the thickness of an electrode mix paint applied to an electrode plate is large, the breakage of the electrode plate or the separation of an active material layer due to stress concentration can be prevented to a certain extent in such a manner that the thickness is gradually reduced from a coated region toward an uncoated region. However, when the thickness is larger or the area of each electrode is larger, there is a problem in that a load is concentrated on a boundary section between the coated region and the uncoated region to cause failures such as the separation and cracking of the active material layer and the abrasion and cracking of a current collector.

Therefore, it is desired for an electrode plate, required to be larger, for secondary batteries that the separation or cracking of an active material layer that is likely to occur in a boundary section between a coated region and an uncoated region, the abrasion or cracking of a current collector, or the like can be more effectively suppressed. The following battery is desired: a secondary battery that can reduce the initial failure rate during manufacture and can enhance load characteristics by the use of an electrode plate in which such failures are unlikely to occur.

Therefore, in view of the above problem, in a secondary battery including a large-sized electrode group including stacked positive and negative electrode plates, it is an object of the present invention to provide an electrode plate in which failures such as the separation and cracking of an active material layer and the abrasion and cracking of a current collector are unlikely to occur.

### Solution to Problem

In order to achieve the above object, the present invention is characterized in that an electrode plate including a current collector and an active material layer formed on the current collector includes a coated region where the active material layer is formed and an uncoated region where no active material layer is formed. An end portion of the coated region that extends to a boundary section between the uncoated region is provided with a first buffer region having a non-linear irregular shape in plan view.

According to this configuration, the boundary section between the coated region and the uncoated region is provided with the first buffer region having the irregular shape and therefore the boundary between the coated region and the uncoated region is not linear and has a plurality of irregular shapes; hence, a load is not concentrated on the active material layer or current collector of the boundary section but is distributed. Therefore, even if the coating thickness of the active material layer is large or the two-dimensional size of the electrode plate is large, the electrode plate in which failures such as the separation and cracking of the active material layer and the abrasion and cracking of the current collector are unlikely to occur can be obtained.

The present invention is characterized in that in the electrode plate having the above configuration, a second buffer region in which the thickness of the active material layer is gradually reduced from the coated region toward the uncoated region is provided. According to this configuration, a load is more unlikely to be concentrated on the buffer region and therefore the separation and cracking of the active material layer, the abrasion and cracking of the current collector, and the like can be more effectively suppressed. A configuration in which the permeation of an electrolyte solution is likely to be promoted is formed to increase the impregnation rate of the electrolyte solution.

The present invention is characterized in that in the electrode plate having the above configuration, the electrode plate is a positive electrode plate and, in the coated region having the uniformly thick active material layer, the coating weight of an effective active material contained in the active material layer is 30 mg/cm² to 76 mg/cm² for both surfaces. Even though the coating weight of the effective active material is large like this configuration, the electrode plate in which failures such as the separation and cracking of the active material layers and the abrasion and cracking of the current collector are unlikely to occur can be obtained by forming a configuration in which the first buffer region having the non-linear irregular shape and the second buffer region in which the thickness of the active material layers is gradually reduced are provided.

The present invention is characterized in that in the electrode plate having the above configuration, the electrode plate is a positive electrode plate and the thickness of the active material layer in the coated region having the uniformly thick active material layer is 150 μm to 650 μm for both surfaces. Even though the electrode plate has such a large spread that the thickness of the active material layers applied to the current collector is 150 μm to 650 μm for both surfaces like this configuration, the electrode plate in which failures such as the separation and cracking of the active material layers and the abrasion and cracking of the current collector are unlikely to occur can be obtained by forming the configuration in which the first buffer region having the non-linear irregular shape and the second buffer region in which the thickness of the active material layers is gradually reduced are provided.

The present invention is characterized in that in the electrode plate having the above configuration, the electrode plate includes positive and negative electrode plates, coated regions having active material layers are placed opposite to each other with separators interposed therebetween to form power generation regions, the power generation regions of the positive electrode plates are placed inside the coated regions of the negative electrode plates that have the uniformly thick active material layers, and the buffer regions of the negative electrode plates are placed outside the coated regions of the positive electrode plates that have the uniformly thick active material layers. According to this configuration, the buffer regions of the negative electrode plates are formed outside the power generation regions and the whole coated regions of the positive electrode plates are formed inside the coated regions of the negative electrode plates that have the uniformly thick active material layers; hence, specified charge-discharge capacity can be precisely exhibited. Furthermore, the deposition of metallic lithium on the negative electrode plates by charge can be prevented and therefore the safety of a secondary battery is increased.

The present invention is characterized in that a secondary battery includes positive electrode plates each including a current collector and an active material layer formed thereon, negative electrode plates each including a current collector and an active material layer formed thereon, and current collector members (current collector terminals) electrically connected to the electrode plates. At least one of the positive electrode plates and the negative electrode plates is the above electrode plate and the current collector members (current collector terminals) are welded to the current collectors in the uncoated region.

According to this configuration, even if the coating thickness of the active material layers of the electrode plate is large or the two-dimensional size of the electrode plate is large, the initial failure rate of the secondary battery can be reduced and load characteristics thereof can be enhanced because the electrode plate in which failures such as the separation and cracking of the active material layers and the abrasion and cracking of the current collector are unlikely to occur is used. Even if external force such as vibration acts on the secondary battery, the above failures are unlikely to occur. Therefore, the secondary battery has increased safety in addition to quake resistance.

### Advantageous Effects of Invention

According to the present invention, even in a secondary battery including a large-sized electrode group including stacked positive and negative electrode plates, an electrode plate in which failures such as the separation and cracking of an active material layer and the abrasion and cracking of a current collector are unlikely to occur can be obtained by forming a configuration in which an end portion of a coated region where the active material layer is formed is provided with a first buffer region having a non-linear irregular shape in plan view, the end portion extending to a boundary section between an uncoated region.

### BRIEF DESCRIPTION OF DRAWINGS

FIG. 1 is a plan view showing an example of an electrode plate according to the present invention.

FIG. 2 is a schematic sectional view illustrating a buffer region of an electrode plate according to the present invention.

FIG. 3 is a schematic plan view illustrating a step of manufacturing an electrode plate according to the present invention.

FIG. 4A is a schematic plan view showing a first embodiment of a buffer region of an electrode plate according to the present invention.

FIG. 4B is a schematic sectional view showing the thickness-wise shape of the buffer region shown in FIG. 4A.

FIG. 5 is a schematic plan view showing a second embodiment of a buffer region.

FIG. 6 is a schematic sectional view showing the state of stacked positive electrode plates and negative electrode plates.

FIG. 7 is an exploded perspective view of a secondary battery.

FIG. 8 is an exploded perspective view of an electrode group included in a secondary battery.

FIG. 9 is a perspective view showing a completed secondary battery.

FIG. 10 is a schematic sectional view of an electrode group placed in a battery can.

FIG. 11 is a perspective view showing the configuration of a compact pack cell which is a laminate pack type of secondary battery.

FIG. 12 is a plan view illustrating a first buffer region of an electrode plate used in the compact pack cell shown in FIG. 11.

FIG. 13 is an illustration showing Structure (a), Structure (b), and Structure (c) relating to a second buffer region of the electrode plate used in the compact pack cell shown in FIG. 11.

### DESCRIPTION OF EMBODIMENTS

Embodiments of the present invention are described below with reference to drawings. The present invention is not limited to them. The same constituent members are denoted by the same reference numerals and will not be redundantly described.

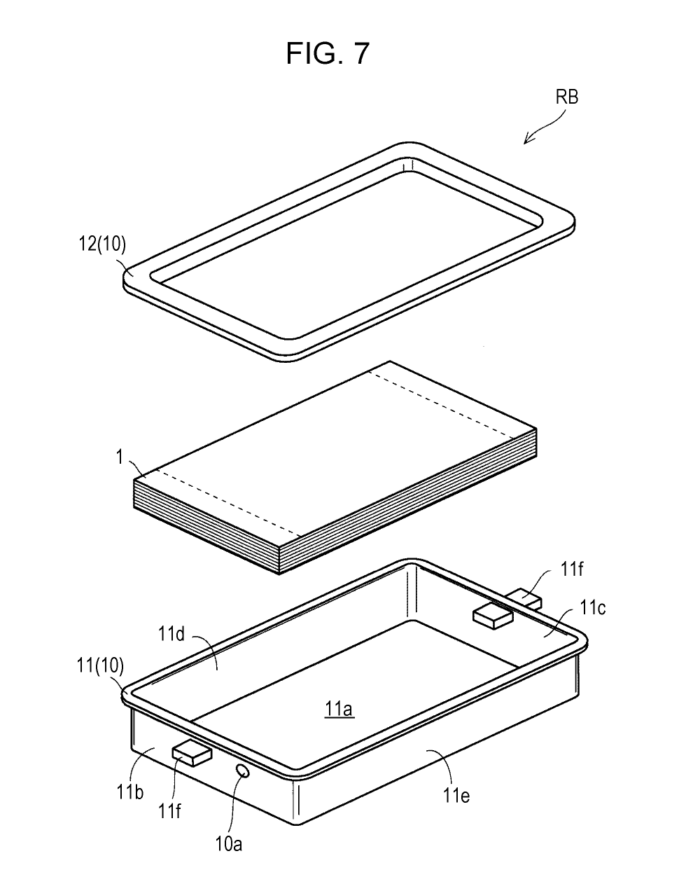

For example, a lithium secondary battery is used as a secondary battery according to the present invention. A secondary battery RB according to this embodiment is a stack type of lithium secondary battery. As shown in FIG. 7, a battery can 10 composed of a cover case 11 and a lid member 12 contains a stacked electrode group 1 including a plurality of stacked positive electrode plates, negative electrode plates, and separators interposed therebetween and is filled with an electrolyte solution. Increasing the area of each electrode plate and the number of stacks provides a relatively high-capacity secondary battery, which can be applied to storage batteries for electric vehicles, storage batteries for power storage, and the like.

The configuration of the stack type of lithium secondary battery RB and the configuration of the electrode group 1 are described below in detail with reference to FIGS. 7 to 10.

As shown in FIG. 7, the stack type of lithium secondary battery RB is rectangular in plan view and includes the electrode group 1, which includes the stacked positive electrode plates, negative electrode plates, and separators, the positive electrode plates, the negative electrode plates, and the separators being rectangular. The cover case 11 includes a bottom portion 11a and side portions 11b to 11e and is box-shaped. It is contained in the substrate 10, which is composed of the cover case 11 and the lid member 12. Charge or discharge is performed through external terminals 11f attached to side surfaces (for example, two side surfaces facing the side portions 11b and 11c) of the cover case 11.

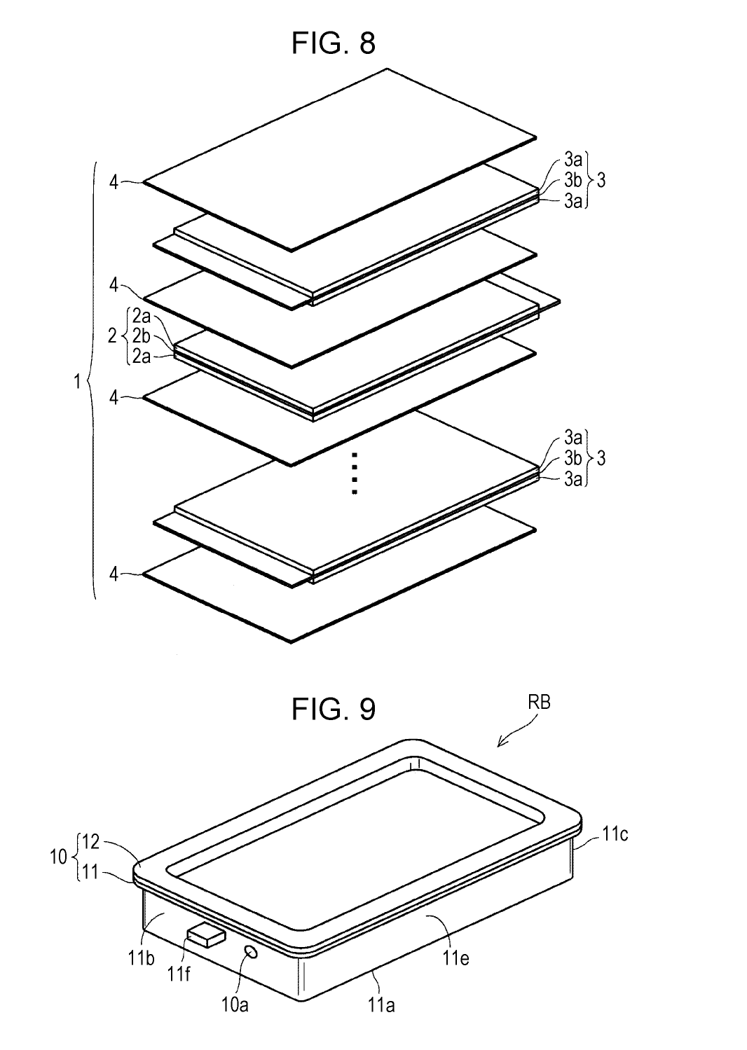

The electrode group 1 has a configuration in which the positive electrode plates and the negative electrode plates are stacked with the separators interposed therebetween. As shown in FIG. 8, the positive electrode plates 2 and the negative electrode plates 3 are stacked with the separators 4 interposed therebetween. Each positive electrode plate 2 includes a positive current collector 2b (for example, aluminium foil) and positive electrode active material layers 2a which are placed on both surfaces of the positive current collector 2b and which are made of a positive electrode active material. Each negative electrode plate 3 includes a negative current collector 3b (for example, copper foil) and negative electrode active material layers 3a which are placed on both surfaces of the negative current collector 3b and which are made of a negative electrode active material.

The positive electrode plates 2 are insulated from the negative electrode plates 3 by the separators 4. Lithium ions can migrate between the positive electrode plates 2 and the negative electrode plates 3 through the electrolyte solution, which is filled in the cover case 11.

Herein, lithium-containing oxides (such as LiCoO₂, LiNiO₂, LiFeO₂, LiMnO₂, and LiMn₂O₄), compounds obtained by partially substituting a transition metal of the oxides by another metal element, and the like are cited as the positive electrode active material of the positive electrode plates 2. In particular, one that can use 80% or more of lithium contained in the positive electrode plates 2 in a battery reaction is used as the positive electrode active material, whereby safety against incidents such as overcharge can be enhanced.

Examples of the positive electrode active material include compounds having a spinel structure like LiMn₂O₄, compounds having an olivine structure represented by LiₓMPO₄ (M is one or more selected from the group consisting of Co, Ni, Mn, and Fe), and the like. In particular, the positive electrode active material preferably contains at least one of Mn and Fe from the viewpoint of cost. Furthermore, LiFePO₄ is preferably used from the viewpoint of safety and charged voltage. LiFePO₄ is excellent in safety because all oxygen (O) is tightly bonded to phosphorus (P) through a covalent bond and therefore the release of oxygen due to an increase in temperature is unlikely to occur.

Alternatively, a positive electrode active material α which has a basic structure of LiFePO₄ and lattice constants (10.326≦a≦10.335, 6.006≦b≦6.012, 4.685≦c≦4.714) and which is represented by the chemical formula LiFe₁₋ₓZrPₓP_{1-y}Si_{y}O₄ is preferably used because the expansion and contraction coefficients during charge and discharge are small.

The present invention characterized in that an electrode plate includes a current collector and an active material layer formed on the current collector and has a coated region where the active material layer is formed and an uncoated region where no active material layer is formed and an end portion of the coated region that extends to a boundary section between the uncoated region is provided with a first buffer region having a non-linear irregular shape in plan view. Furthermore, it is characterized in that a second buffer region in which the thickness of the active material layer is reduced from the coated region toward the uncoated region is placed.

The volume expansion and contraction coefficients of particles of the positive electrode active material a during charge and discharge are small and therefore the expansion and contraction of the whole electrode active material layer can be suppressed. Combining this and the above configuration allows the separation of the active material layer to be prevented after a long cycle. Furthermore, since the volume expansion and contraction coefficients of the particles of the positive electrode active material α during charge and discharge are small, the cycle deterioration of load characteristics of the particles is slight and therefore low-temperature properties after a long cycle are significantly enhanced. An irregular structure of this patent has a stress-relieving effect. However, it is difficult to impart sufficient binding strength to a convex portion because of the complicated structure thereof. The pH of aqueous slurry made from the active material α tends to be higher than that of other active materials because of the nature of the active material α. A surface of Al foil is adequately roughened by oxidation during slurry coating and therefore the binding strength of the active material layer is significantly increased. In particular, a convex portion of the irregular structure of this patent can have locally very high binding strength due to this reason because the concentration of solid in slurry is low during slurry coating and therefore oxidizability is increased. This allows the irregular structure to be readily formed and also allows an electrode having excellent properties due to high binding strength to be obtained.

The lattice constants are determined as described below. A sample (positive electrode active material) was crushed in an agate mortar and a powder X-ray diffraction pattern was obtained using an X-ray analyzer, MiniFlex II (manufactured by Rigaku Corporation). Measurement conditions were set to a voltage of 30 kV, a current of 15 mA, a divergence slit of 1.25°, a receiving slit of 0.3 mm, a scattering slit of 1.25°, a 28 range of 10° to 90°, a step of 0.02° and the measurement time for each step was adjusted such that the maximum peak intensity was 800 to 1,500.

Next, for the obtained powder X-ray diffraction pattern, the Rietveld analysis software RIETAN-FP (F. Izumi and K. Momma, “Three-dimensional visualization in powder diffraction”, Solid State Phenom., 130, 15-20 (2007)) was used, an ins file was prepared using parameters shown in Table α as initial values, structural analysis was performed by Rietveld analysis using DD3.bat, and parameters were read from a 1st file, whereby the lattice constants were determined (the S value (degree of convergence) was 1.1 to 1.3).

TABLE α

| | | | |
|---|---|---|---|
| Space group | Pnma | Orientation | (100) |
| Lattice | a | b | c |
| constants | 10.3270 | 6.0060 | 4.6966 |

| Element | Site name | Occupancy | x | y | z |
|---|---|---|---|---|---|
| Li | 4a | 1 | 0 | 0 | 0 |
| Fe | 4a | 0 | 0 | 0 | 0 |
| Zr | 4a | 0 | 0 | 0 | 0 |
| Fe | 4c | Allocated | 0.282 | 0.250 | 0.974 |
| Zr | 4c | depending on | 0.282 | 0.250 | 0.974 |
| | | charge ratio | | | |
| P | 4c | Allocated | 0.095 | 0.250 | 0.419 |
| Si | 4c | depending on | 0.095 | 0.250 | 0.419 |
| | | charge ratio | | | |
| O | 4c | 1 | 0.097 | 0.250 | 0.741 |
| O | 4c | 1 | 0.453 | 0.250 | 0.213 |
| O | 8d | 1 | 0.165 | 0.045 | 0.282 |

A material containing lithium or a material capable of intercalating and deintercalating lithium is used as the negative electrode active material of the negative electrode plates 3. In particular, in order to allow it to have high energy density, one having a lithium intercalation/deintercalation potential close to the deposition/dissolution potential of metallic lithium is preferably used. A typical example thereof is particulate (scaly, massive, fibrous, whisker-shaped, spherical, fine particle-shaped, or the like) natural or artificial graphite.

Incidentally, the active material layers of the positive electrode plates 2 and the active material layers of the negative electrode plates 3 may contain a conductive material, a thickening agent, a binding material, and the like in addition to the positive electrode active material and the negative electrode active material, respectively. The conductive material is not particularly limited and may be an electron-conducting material not adversely affecting the battery performance of the positive electrode plates 2 and the negative electrode plates 3. For example, a carbonaceous material such as carbon black, acetylene black, Ketjenblack, graphite (natural graphite, artificial graphite), or a carbon fiber; a conductive metal oxide, or the like can be used.

The following compounds can be used as the thickening agent: for example, polyethylene glycols, celluloses, polyacrylamides, poly-N-vinylamides, poly-N-vinylpyrrolidones, and the like. The binding material has a role in binding particles of an active material and particles of the conductive material. The following materials can be used: fluorinated polymers such as polyvinylidene fluoride, polyvinylpyridine, and polytetrafluoroethylene; polyolefin polymers such as polyethylene and polypropylene; styrene-butadiene rubber; and the like.

Microporous polymeric films are preferably used as the separators 4. In particular, the following films can be used: films made of nylon, cellulose acetate, nitrocellulose, polysulfone, polyacrylonitrile, or a polyolefin polymer such as polyvinylidene fluoride, polypropylene, polyethylene, or polybutene.

An organic electrolyte solution is preferably used as the electrolyte solution. In particular, the following compounds can be used as organic solvents for the organic electrolyte solution: esters such as ethylene carbonate, propylene carbonate, butylene carbonate, diethyl carbonate, dimethyl carbonate, ethyl methyl carbonate, and γ-butyrolactone; ethers such as tetrahydrofuran, 2-methyltetrahydrofuran, dioxane, dioxolane, diethyl ether, dimethoxyethane, diethoxyethane, and methoxyethoxyethane; dimethyl sulfoxide; sulfolane; methylsulfolane; acetonitrile; methyl formate; methyl acetate; and the like. Incidentally, these organic solvents may be used alone or in combination.

The organic solvent may further contain an electrolyte salt. Examples of the electrolyte salt include lithium salts such as lithium perchlorate (LiClO₄), lithium borofluoride, lithium hexafluorophosphate, trifluoromethanesulfonic acid (LiCF₃SO₃), lithium fluoride, lithium chloride, lithium bromide, lithium iodide, and lithium tetrachloroaluminate. Incidentally, these electrolyte salts may be used alone or in combination.

The concentration of the electrolyte salt is not particularly limited, is preferably about 0.5 mol/L to 2.5 mol/L, and is more preferably about 1.0 mol/L to 2.2 mol/L. When the concentration of the electrolyte salt is lower than about 0.5 mol/L, the concentration of carriers in the electrolyte solution is low and therefore the resistance of the electrolyte solution may possibly be high. However, when the concentration of the electrolyte salt is higher than about 2.5 mol/L, the degree of dissociation of the salt is low and therefore the concentration of the carriers in the electrolyte solution may possibly be not increased.

The battery can 10 includes the cover case 11 and the lid member 12 and is made of iron, nickeled iron, stainless steel, aluminium, and the like. In this embodiment, as shown in FIG. 9, the battery can 10 is configured such that the appearance thereof has substantially a flat rectangular shape when the cover case 11 and the lid member 12 are combined together.

The cover case 11 includes a bottom portion 11a having a bottom surface with substantially a rectangular shape and four side portions 11b to 11e erected from the bottom portion 11a , has a box shape, and contains the electrode group 1 in the box shape. The electrode group 1 includes a positive current collector terminal connected to collector tabs of the positive electrode plates and a negative current collector terminal connected to collector tabs of the negative electrode plates. The external terminals 11f are electrically connected to these collector tabs and are each attached to a corresponding one of side portions of the cover case 11. The external terminals 11f are each attached to, for example, a corresponding one of the two side portions 11b and 11c , which face each other. Reference numeral 10a represents a liquid inlet through which the electrolyte solution is introduced.

After the electrode group 1 is placed in the cover case 11 and each of the current collector terminals is connected to a corresponding one of the external terminals or after each of the external terminals is connected to a corresponding one of the current collector terminals of the electrode group 1, it is placed in the cover case 11, and the external terminals are fixed to predetermined portions of the cover case, the lid member 12 is fixed to an open edge of the cover case 11. This allows the electrode group 1 to be sandwiched between the bottom portion 11a of the cover case 11 and the lid member 12; hence, the electrode group 1 is held in the battery can 10. Incidentally, the lid member 12 is fixed to the cover case 11 by, for example, laser welding. The edge of the cover case 11 and the edge of the lid member 12 may be swaged together so as to be hermetically sealed. The current collector terminals can be connected to the external terminals using a conductive adhesive or the like except welding including ultrasonic welding, laser welding, and resistance welding.

As described above, the stack type of secondary battery RB according to this embodiment includes the electrode group 1, in which the positive electrode plates 2 and the negative electrode plates 3 are stacked with the separators 4 interposed therebetween; the cover case 11, which contains the electrode group 1 and in which the electrolyte solution is filled; the external terminals 11f, which are attached to the cover case 11; the positive and negative current collector terminals 5, which electrically connect the positive and negative electrode plates to the external terminals 11f; and the lid member 12, which is attached to the cover case 11.

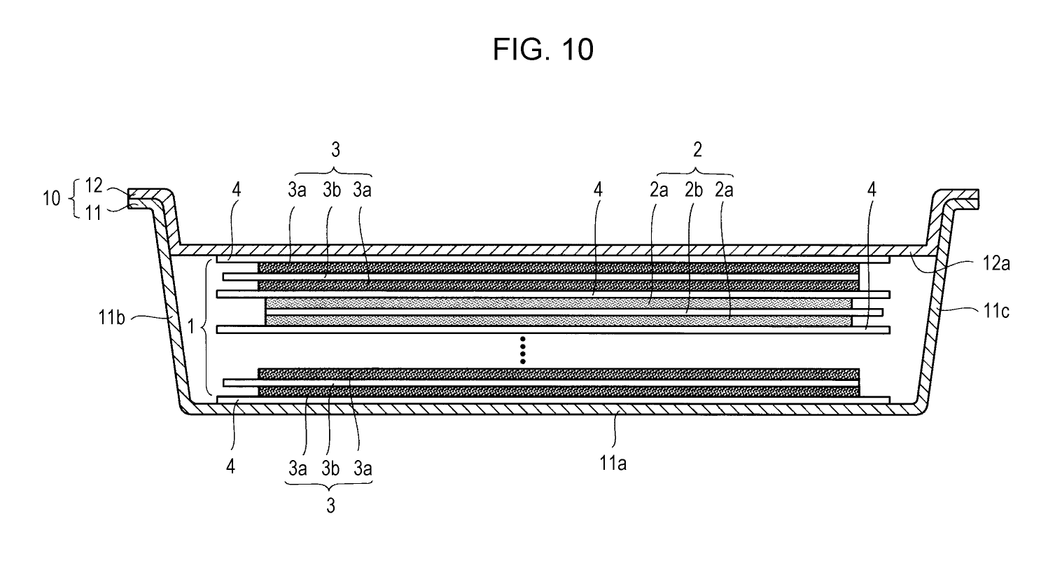

In the electrode group 1, which is placed in the cover case 11, as shown in, for example, FIG. 10, the positive electrode plates 2, in which the positive electrode active material layers 2a are placed on both surfaces of each positive current collector 2b, and the negative electrode plates 3, in which the negative electrode active material layers 3a are placed on both surfaces of each negative current collector 3b, are stacked with the separators 4 interposed therebetween and the separators 4 are placed on both end surfaces thereof. A resin film made of the same material as the separators 4 may be wound around the electrode group 1 instead of the separators 4 on both end surfaces thereof such that the electrode group 1 is insulated and is covered. In either case, the upper surface of the electrode group 1 is overlaid with a member having electrolyte solution permeability and insulating properties. Therefore, the lid member 12 is allowed to directly abut onto this surface, which can be pressed with a predetermined pressure through the lid member.

In order to exhibit high capacity, the area of each of the positive and negative electrode plates is increased, the number of stacks is increased, and the amount of the filled electrolyte solution is also increased. Furthermore, the thickness of a layer of an active material applied to each electrode plate tends to be increased. In the case of manufacturing the positive or negative electrode plates, after, for example, an electrode mix paint containing the pasty positive electrode active material is applied to both surfaces of aluminium foil for forming the current collectors of the positive electrode plates to a predetermined thickness and is dried, it is pressed with a roll press and is then cut into pieces with a predetermined size.

A region of each electrode plate that is connected to a corresponding one of the current collector terminals 5 is an uncoated region where no active material layer is formed. A coated region coated with the electrode mix paint and the uncoated region, which is not coated with the electrode mix paint are present in the electrode plate. That is, when the positive electrode plates and the negative electrode plates are manufactured, a boundary section between the coated region and the uncoated region is formed on a portion of each current collector.

In such a state, when the thickness of each active material layer is large, the difference in level between the coated region and the uncoated region, that is, the difference in level of the boundary section is large and therefore a load is likely to be concentrated on the boundary section to cause failures such as the separation and cracking of the active material layer and the abrasion and cracking of the current collector. Therefore, in this embodiment, buffer regions are provided for the purpose of suppressing failures due to the boundary section such that a load is unlikely to be concentrated on the boundary section.

A load due to a large area is increased in addition to the increase in load due to the above thickness. Therefore, in this embodiment, the buffer regions are provided so as to exert effects on both the loads.

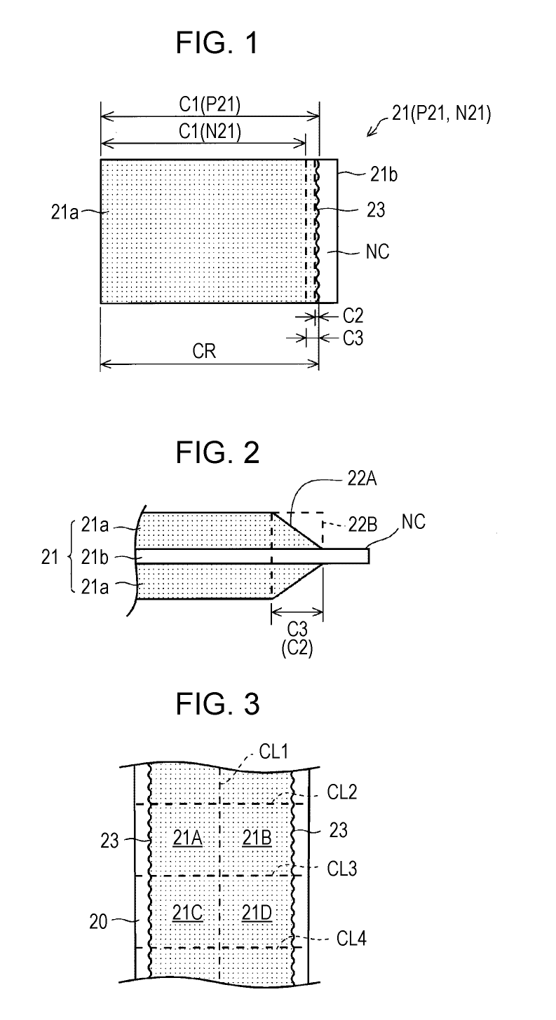

The buffer regions are described below in detail with reference to FIGS. 1 to 6.

FIG. 1 is a plan view of an example of an electrode plate according to this embodiment and FIG. 2 is a schematic sectional view of a buffer region thereof. The electrode plate 21 (P21, N21) is rectangular in plan view and has a configuration in which active material layers 21a are placed on both surfaces of a tabular current collector 21b as shown in FIG. 1.

It includes an uncoated region NC where none of the active material layers 21a is formed and where the current collector 21b is exposed. A current collector terminal 5 is connected to the uncoated region NC and is attached to a current collector tab. That is, the electrode plate 21 includes a coated region CR coated with the active material layers 21a, the uncoated region NC, which is not coated with the active material layers 21a, and a boundary section 23 therebetween.

Therefore, when the thickness of the active material layers 21a is large, a load is likely to be concentrated on the boundary section 23 to cause failures such as the separation and cracking of the active material layers 21a and the abrasion and cracking of the current collector 21b. In this embodiment, in order to suppress the concentration of a load on the boundary section 23, an end portion of the coated region CR that extends to the boundary section 23 is provided with a first buffer region C2 having a non-linear irregular shape in plan view.

For example, a shape in a plan view direction is set to a non-linear irregular shape such as a wave shape, a sawtooth shape, or an angular irregular shape, whereby the concentration of a load on the boundary section 23 is suppressed. Furthermore, in addition to the first buffer region C2, a second buffer region C3 in which the thickness of each active material layer is gradually reduced from the coated region toward the uncoated region may be provided.

In either case, it is desired that a load is unlikely to be concentrated on the boundary section 23, which is present between the coated region CR and the uncoated region NC, depending on the thickness and size of the electrode plate. Even in the case of a uniform thickness, the plan view shape of the boundary section 23 can be formed by providing the first buffer region C2, which has a non-linear irregular shape composed of a plurality of irregularities, such that a load is unlikely to be concentrated on the boundary section 23. Furthermore, the concentration of a load can be more effectively suppressed by varying a thickness-wise shape (providing the second buffer region C3, in which the thickness of each active material layer is gradually reduced from the coated region toward the uncoated region).

That is, this embodiment provides a configuration in which the electrode plate 21 for secondary batteries includes the current collector 21b and the active material layers 21a placed on the current collector, it has the coated region CR where the active material layers 21a are formed and the uncoated region NC where none of the active material layers 21a is formed, and an end portion of the coated region CR that extends to the boundary section 23 between the coated region CR and the uncoated region NC is provided with buffer regions (including at least the first buffer region C2 having the non-linear irregular shape in plan view) such that the concentration of a load on the boundary section 23 is suppressed.

According to this configuration, a load is not concentrated on the boundary section 23 between the coated region CR and the uncoated region NC but is distributed. Therefore, the electrode plate 21 can be obtained such that even if the formed active material layers 21a are thick or the two-dimensional size of the electrode plate is large, failures such as the separation and cracking of the active material layers 21a and the abrasion and cracking of the current collector 21b are unlikely to occur.

Electrode plates 21 include positive and negative electrode plates (positive electrode plates P21 and negative electrode plates N21) and the coated regions CR having the active material layers 21a are placed opposite to each other with the separators 4 interposed therebetween to form power generation regions C1. Active material layers of the negative electrode plates N21 are formed so as to be slightly larger than active material layers of the positive electrode plates P21 such that the whole coated regions of the positive electrode plates P21 face coated regions of the negative electrode plates N21 that have the active material layers which are uniform in thickness. This allows the metal deposition of lithium ions which are released from the active material layers of the positive electrode plates P21 and which are not absorbed in the active material layers of the negative electrode plates N21 on, for example, the negative electrode plates N21 to be suppressed.

That is, the power generation regions C1 of the positive electrode plates P21 are placed inside the coated regions of the negative electrode plates N21 that have the active material layers which are uniform in thickness and buffer regions of the negative electrode plates N21 are placed outside the coated regions of the positive electrode plates P21 that have the active material layers which are uniform in thickness. This configuration can precisely exhibit specified charge-discharge capacity because the buffer regions of the negative electrode plates N21 are formed outside the power generation regions C1. Furthermore, the deposition of metallic lithium on the negative electrode plates N21 by charge can be prevented and therefore the safety of the secondary battery RB is increased.

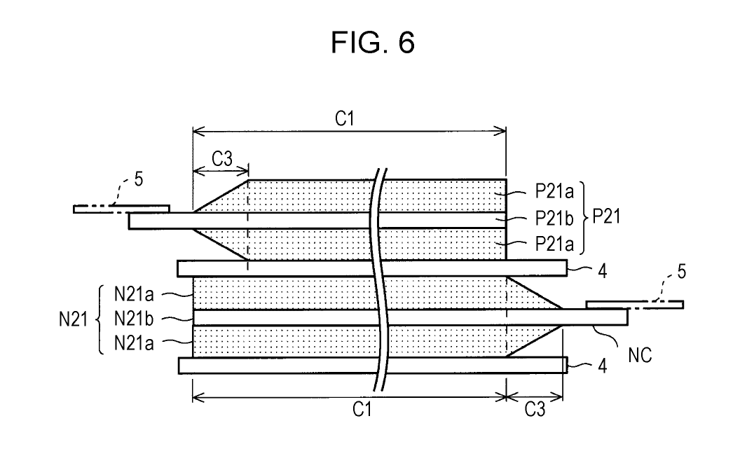

For example, in the case of stacking the positive electrode plates P21 and the negative electrode plates N21 with the separators 4 interposed therebetween as shown in FIG. 6, the coated regions of the negative electrode plates N21 that have the active material layers N21a which are uniform in thickness correspond to the power generation regions C1. The power generation regions C1 of the positive electrode plates P21 are regions including the second buffer region C3 (including the first buffer region C2) and the whole coated regions of the positive electrode plates P21 correspond to the power generation regions C1.

Thus, in the case of the negative electrode plates N21, the second buffer region C3 (including the first buffer region C2) are placed outside the power generation regions C1 and the current collector terminals 5 are connected to the uncoated region NC not coated with the active material layers N21a by, for example, welding. The second buffer region C3 (including the first buffer region C2) of the positive electrode plates P21 are placed inside the coated regions (corresponding to the power generation regions C1) of the negative electrode plates N21 that have the active material layers which are uniform in thickness.

That is, the electrode plates 21 (electrode plates for secondary batteries) according to this embodiment include the positive and negative electrode plates (the positive electrode plates P21 and the negative electrode plates N21), the buffer regions C2 and C3 of the negative electrode plates N21 are formed outside the power generation regions C1 thereof, and the buffer regions C2 and C3 of the positive electrode plates P21 are formed inside the power generation regions C1 thereof. This configuration can precisely exhibit specified charge-discharge capacity because the whole coated regions of the positive electrode plates P21 that include the buffer regions are placed inside the coated regions of the negative electrode plates N21 that have the active material layers which are uniform in thickness so as to be opposite to each other. Furthermore, the deposition of metallic lithium on the negative electrode plates N21 by charge can be prevented and therefore the safety of the secondary battery RB is increased.

The first buffer region C2 is configured such that the boundary section between the coated region CR and the uncoated region NC has a wavy irregular shape 23A in plan view. This configuration allows the boundary section between the coated region CR and the uncoated region NC to be not linear and therefore is a configuration in which loads are not concentrated on the active material layers 21a and current collector 21b of the boundary section 23 but are distributed. That is, forming the wavy irregular shape 23A allows the first buffer region C2 to prevent a load from being concentrated on the boundary section 23. Even if the coated active material layers 21a are thickness or the two-dimensional size of each electrode plate is large, the electrode plates 21 in which failures such as the separation and cracking of the active material layers 21a and the abrasion and cracking of the current collector 21b are unlikely to occur can be obtained.

In addition to the first buffer region C2, the second buffer region C3 is preferably provided such that the thickness of the active material layers 21a is gradually reduced. This configuration is a configuration in which a load is unlikely to be concentrated and therefore the separation and cracking of the active material layers 21a and the abrasion and cracking of the current collector 21b can be more effectively suppressed. In particular, the cracking of the current collector 21b in the boundary section 23 can be reliably prevented during pressing with a roll press. The active material layers 21a in the second buffer region C3 are low-density layers permeable to the electrolyte solution and therefore the impregnation rate of the electrolyte solution is increased.

Configurations which gradually become thin are, for example, sloped end portions 22A which are linearly tapered as shown in FIG. 2. When the thickness of the active material layers 21a is relatively small, end portions 22B may be substantially invariable in thickness. In this case, when the boundary section 23 has the wavy irregular shape 23A, a buffer region (the first buffer region C2) on which a load is unlikely to be concentrated can be formed.

A method for manufacturing the electrode plates 21 for secondary batteries is briefly described below with reference to FIG. 3.

An electrode mix paint containing a pasty positive or negative electrode active material that is an electrode material is uniformly applied to running elongated metal foil 20 that is a material for the current collector 21b using a coating die (coating nozzle). After being dried, it is pressed with a roll press and is then cut into pieces with a predetermined size, whereby tabular electrode plates were manufactured.

The electrode mix paint may be applied to both surfaces of the metal foil 20 and may be then dried. Alternatively, after the electrode mix paint is applied to a surface thereof and is then dried, the electrode mix paint may be applied to an opposite surface thereof and may be then dried. In either case, uncoated regions uncoated with the electrode mix paint are provided at the right and left ends of the figure and it is dried, is pressed with the roll press, and is then cut along cutting lines CL1 to CL4, whereby electrode plates 21A to 21D are prepared. That is, the metal foil 20 is an elongated member having a width equal to twice the width of the tabular electrode plates 21 and both side portions of the metal foil 20 are provided with the uncoated regions uncoated with the electrode mix paint, whereby a plurality of the electrode plates 21 including the coated region CR and the uncoated region NC are collectively manufactured.

A method for allowing the boundary section between the coated region and the uncoated region to have the wavy irregular shape 23A can be performed in such a manner that, for example, a plurality of coating dies are arranged in a thickness direction and only the coating dies located at both ends are swung. It can be also performed in such a manner that the electrode mix paint is intermittently supplied from the coating dies located at both ends or the running speed of the metal foil 20 is periodically varied. Furthermore, after it is applied to a uniform thickness over the entire width, it may be formed by cutting so as to have a predetermined shape and thickness.

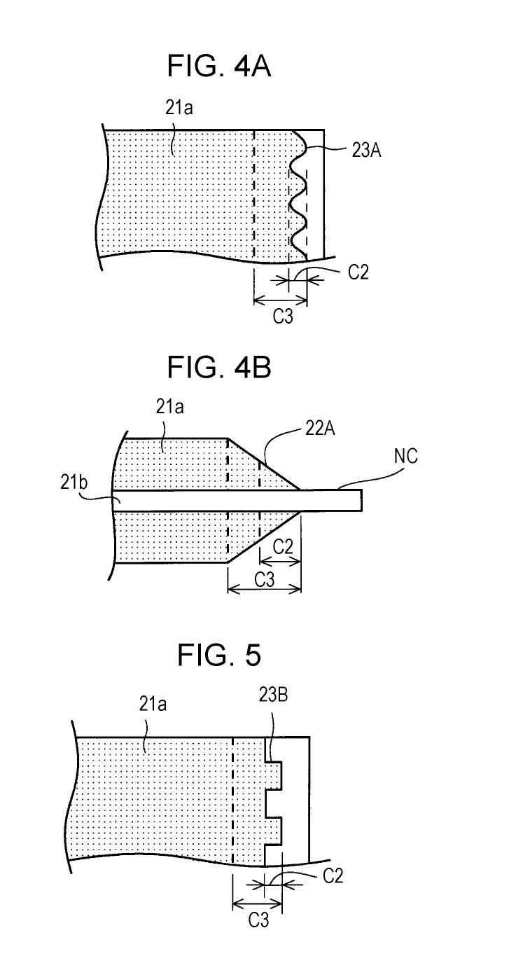

The shape of the boundary section 23 is preferably an irregular shape in plan view. In this embodiment, the wavy irregular shape 23A is employed. The wavy irregular shape 23A is further described with reference to FIGS. 4A and 4B.

The width of a buffer region hereinafter refers to the width in a direction perpendicular to a coating direction of the metal foil 20 unless otherwise specified. As shown in FIG. 4A, an end of the second buffer region C3 is provided with the first buffer region C2 (a width of, for example, about 2 mm) having the wavy irregular shape 23A. Alternatively, as shown in FIG. 4B, the second buffer region C3 has a sloped end portion 22A and the first buffer region C2 having the wavy irregular shape 23 is placed on the edge side thereof. In this case, the second buffer region C3 may have a width (for example, about 4 mm) greater than or equal to the width of the first buffer region C2 as shown in the figure. This is because the width of the buffer regions C2 and C3 needs to be small, depending on the thickness and size of the electrode plates, for a configuration in which a load is unlikely to be concentrated on the boundary section 23.

That is, depending on the thickness and size of the electrode plates 21, the first buffer region C2 which is uniform in thickness and which is varied in shape in plan view may be provided and the second buffer region C3 which is varied in thickness may be provided in addition to the first buffer region C2.

An irregular shape imparted to the boundary section 23 may be an angular wavy irregular shape and therefore an example (second embodiment) thereof is described with reference to FIG. 5.

An irregular shape 23B shown in FIG. 5 is an irregular shape according to a second embodiment and has angular irregularities. In this case, the second buffer region C3 can be provided such that the thickness of the active material layers 21a is gradually reduced from the coated region CR toward the uncoated region NC. The second buffer region C3 may have a width substantially equal to the width (for example, about 2 mm) of the first buffer region C2 provided with the angular wavy irregular shape 23B or a slightly larger width (for example, about 4 mm) as shown in the figure.

The secondary battery, including the electrode plates having the above configuration, according to this embodiment is described below again.

The secondary battery RB according to this embodiment includes the positive and negative electrode plates P21 and N21 which each include the current collector 21b and the active material layers 21a formed thereon and also includes current collector members (current collector terminals 5) electrically connected to these electrode plates. At least either of the positive electrode plates P21 and the negative electrode plates N21 are the above-mentioned electrode plates 21. The current collector members (current collector terminals 5) are welded to the current collectors 21b in the uncoated regions NC of the electrode plates 21.

That is, the electrode plates 21 used have a configuration in which end portions of the coated regions CR of the electrode plates 21 are provided with first buffer regions C2 having a non-linear irregular shape in plan view and second buffer regions C3 in which the thickness of the active material layers 21a is gradually reduced. Therefore, even if the thickness of the active material layers 21a is large or the two-dimensional size of the electrode plates is large, failures such as failures such as the separation and cracking of the active material layers 21a and the abrasion and cracking of the current collectors 21b are unlikely to occur in the electrode plates 21; hence, the initial failure rate of the secondary battery RB can be reduced and load characteristics thereof can be enhanced. Even if external force such as vibration acts on the secondary battery RB, the above failures are unlikely to occur. Therefore, the secondary battery RB has increased safety in addition to quake resistance.

In the secondary battery RB having the above configuration, the positive electrode plates P21 and the negative electrode plates N21 are arranged such that the coated regions CR having the active material layers which are uniform in thickness are placed opposite to each other with the separators 4 interposed therebetween to form the power generation regions C1. Power generation regions of the positive electrode plates P21 are placed inside the coated regions of the negative electrode plates N21 that have the active material layers which are uniform in thickness and the buffer regions (first buffer regions C2 and second buffer regions C3) of the negative electrode plates N21 are placed outside the coated regions of the positive electrode plates P21 that have the active material layers which are uniform in thickness. According to this configuration, the buffer regions C2 and C3 of the negative electrode plates N21 are placed outside the power generation regions C1 and all the coated regions including the buffer regions of the positive electrode plates P21 are placed in the coated regions of the negative electrode plates N21 that have the active material layers which are uniform in thickness; hence, specified charge-discharge capacity can be precisely exhibited. Furthermore, the deposition of metallic lithium on the negative electrode plates N21 by charge can be prevented and therefore the safety of the secondary battery RB is increased.

The following results are described below: experiment results of examples and comparative examples in which stack-type lithium secondary batteries having a predetermined structure were actually manufactured and whether failures occurred in electrode plates was confirmed.

### EXAMPLE

### [Preparation of Positive Electrode Plates]

LiFePO₄ (90 parts by weight) as a positive electrode active material, acetylene black (5 parts by weight) as a conductive material, and polyvinylidene fluoride (5 parts by weight) as a binding material were mixed together, N-methyl-2-pyrrolidone as a solvent was appropriately added thereto, and the materials were dispersed therein, whereby slurry was prepared. After the slurry was uniformly applied to both surfaces of aluminium foil (a thickness of 20 μm) as a positive current collector and was then dried, it was pressed with a roll press and was cut into pieces with a predetermined size, whereby tabular electrode plates 2 were manufactured.

A sloped second buffer region C3 with a width of 4 mm was provided between an uncoated region and a power generation region coated with an active material to a predetermined thickness and a first buffer region C2 having a width of 2 mm and a wavy irregular shape was provided at the edge thereof. The prepared positive electrode plates had a size of 145 mm×312 mm (a coated region was 145 mm×299 mm) and a thickness of 330 μm. Thirty two of the positive electrode plates 2 were used.

### [Preparation of Negative Electrode Plates]

Natural graphite (95 parts by weight) as a negative electrode active material and polyvinylidene fluoride (5 parts by weight) as a binding material were mixed together, N-methyl-2-pyrrolidone as a solvent was appropriately added thereto, and the materials were dispersed therein, whereby slurry was prepared. After the slurry was uniformly applied to both surfaces of copper foil (a thickness of 10 μm) as a negative current collector and was then dried, it was pressed with a roll press and was cut into pieces with a predetermined size, whereby tabular negative electrode plates 3 were manufactured.

A sloped second buffer region C3 with a width of 4 mm was provided between an uncoated region and a power generation region coated with an active material to a predetermined thickness and a first buffer region C2 having a width of 2 mm and a wavy irregular shape was provided at the edge thereof. The prepared negative electrode plates had a size of 153 mm×315 mm (a coated region was 153 mm×307 mm) and a thickness of 205 μm. Thirty three of the negative electrode plates 3 were used.

### [Preparation of Separators]

Furthermore, 64 polyethylene films having a size of 153 mm×311 mm and a thickness of 25 μm were prepared as separators.

### [Preparation of Non-Aqueous Electrolyte Solution]

A non-aqueous electrolyte solution was prepared in such a manner that 1 mol/L of LiPF₆ was dissolved in a mixed solution (solvent) prepared by mixing ethylene carbonate (EC) and diethyl carbonate (DEC) at a volume ratio of 30:70.

### [Preparation of Battery Can]

A cover case and lid member making up a battery can were prepared using nickel-plated steel sheets. For dimensions thereof, the thickness was basically 0.8 mm and the size of the can, that is, the longitudinal, lateral, and depth-wise inside dimensions thereof were basically 380 mm, 160 mm, and 45 mm, respectively. Furthermore, a 0.8 mm thick angular battery can equipped with a stepped lid member was prepared.

### [Assembly of Secondary Battery]

The positive electrode plates and the negative electrode plates were alternately stacked with the separators interposed therebetween. In this operation, 32 of the positive electrode plates, 33 of the negative electrode plates, and 64 of the separators were stacked such that the negative electrode plates were located outside the positive electrode plates. A polyethylene film having a thickness of 25 μm, that is, the same thickness as that of the separators was wound around the stack, whereby an electrode group (stack) was constructed.

The separators interposed between the positive and negative electrode plates had a size of 153 mm×311 mm as described above and were capable of reliably covering active material layers formed in coated regions (145×299) of the positive electrode plates and coated regions (153 ×307) of the negative electrode plates. Current collector members (current collector terminals) were connected to uncoated regions of the positive and negative electrode plates.

The electrode group connected to the current collector terminals was provided in the cover case, the current collector terminals were connected to external terminals, and the lid member was attached thereto, followed by hermetical sealing. The non-aqueous electrolyte solution was introduced through a liquid inlet at a reduced pressure in a vacuum liquid-introducing step (a liquid-introducing step and a degassing step). After liquid introducing, the liquid inlet was sealed, whereby each secondary battery (Example 1) according to this embodiment was prepared.

### COMPARATIVE EXAMPLE

As a secondary battery of a comparative example, positive electrode plates and negative electrode plates were prepared, the number and size of the positive and negative electrode plates being the same as those described in the above example except that buffer regions C2 and C3 were not formed. Each secondary battery (Comparative Example 1) was prepared using a battery can having the same thickness as that described in the above example.

Tests below were performed using two types of secondary batteries of Example 1 and Comparative Example 1. Test 1: The comparison of the frequency of a two-plate pickup error in an electrode plate-stacking step. Test 2: The comparison in initial failure rate between the secondary batteries (the frequency of short circuiting and failures in a battery-preparing step).

Test 3: The comparison of initial load characteristics (results of an initial property-evaluation step). Test 4: The comparison of the deterioration of load characteristics after a vibration test (charge-discharge measurement before and after the vibration test).

The two-plate pickup error in Test 1 is such an error that when the negative electrode plates and the positive electrode plates are alternately stacked, two of the stacked plates are attracted in the course of attracting and stacking the electrode plates one by one. The two-plate pickup error occurs in the positive electrode plates. The initial failure rate in Test 2 is the percentage of secondary batteries that do not exhibit predetermined charge-discharge capacity after the manufacture of the secondary batteries (including short circuiting). The initial load characteristics in Test 3 include the proportion of the discharge capacity at a discharge rate of 1 C to the discharge capacity at a discharge rate of 0.1 C. The deterioration of load characteristics is the reduction of the above proportion before and after the vibration test.

The vibration test was performed in each of three axis (x-axis, y-axis, and z-axis) directions for 3 hours and 45 minutes (11 hours and 15 minutes in total). In particular, the vibration test was performed at a frequency ranging from 5 Hz to 200 Hz to 5 Hz and an acceleration ranging from 1 G to 8 G to 1 G in each direction for 15 minutes per set 15 times (3 hours and 45 minutes in total).

Results the tests are shown in Table 1.

TABLE 1

| | Test 1 | Test 2 | Test 3 | Test 4 |
|---|---|---|---|---|
| | Two-plate | Initial | Initial | degree of |
| | pickup | failure | load | deterioration of |
| | error | rate | characteristics | load characteristics |
| Example 1 | 0% | 2% | 98.9% | 98.0% |
| Comparative | 5% | 5% | 96.8% | 88.3% |
| Example 1 | | | | |

The test results revealed that in Example 1 (the electrode plates provided with the first buffer regions C2 and the second buffer regions C3) according to this embodiment, the two-plate pickup error was improved from 5% in Comparative Example 1 to 0% and the initial failure rate was improved from 5% in Comparative Example 1 to 2%. Furthermore, the initial load characteristics were improved from 96.8% to 98.9%. It turned out that after the vibration test was performed, load characteristics of Comparative Example 1 were deteriorated to 88.3% and Example 1 exhibited a high value of 98.0%. Furthermore, after the vibration test was performed, repeating charge and discharge caused Comparative Example 1 to lead to short circuiting.

The improvement of the two-plate pickup error in Test 1 is probably due to the fact that cracks or wrinkles are unlikely to be caused particularly in the boundary sections during the drying of the electrode plates and the cracking and separation of the active material layers in the boundary sections, the camber of the electrode plates, the cracking of the current collectors, and the like are suppressed in a pressing step. The improvement of the initial failure rate in Test 2 is probably due to the fact that the cracking and separation of the active material layers in the boundary sections, the abrasion and cracking of the current collectors, and the like are suppress in a battery-assembling step in addition to the above factor.

The improvement of the load characteristics in Tests 3 and 4 is probably due to the fact that loads on the boundary sections are reduced. Since the boundary sections have a wavy irregular shape and a sloped shape in which the thickness of the active material layers is gradually reduced, the area in contact with the electrolyte solution is increased and the impregnation rate of the electrolyte solution is increased due to the presence of low-density portions in the active material layers; hence, the impregnation time can be reduced.

Since the boundary section between the coated region and uncoated region of each electrode plate is provided with the buffer regions (the first buffer region C2 and the second buffer region C3), the two-plate pickup error is improved and the initial failure rate is reduced during manufacture. Furthermore, the deterioration of load characteristics of products can be suppressed. These effects are noticeable particularly in an electrode plate with a large surface area and an electrode plate including active material layers with a large coating thickness; hence, the configuration of an electrode plate according to this embodiment is preferably used for electrode plates with a larger coating thickness.

The thickness of the positive electrode plates used in Example 1 is 330 μm and the thickness of the (positive electrode) active material layers is 155 μm per surface. The thickness of the negative electrode plates is 205 μm and the thickness of the (negative electrode) active material layers is 97.5 μm per surface. It has turned out that in the case of such thicknesses, a second buffer region C3 with a width of 4 mm is provided and the edge thereof may be provided with a first buffer region C2 having a width of 2 mm and a wavy irregular shape. Even in the case where the thickness of active material layers for constructing a secondary battery with a larger capacity is large, for example, up to 300 μm per surface, a boundary section with a size unlikely to cause failures such as the separation and cracking of active material layers and the abrasion and cracking of a current collector may be provided depending on the thickness thereof.

In the case of manufacturing a secondary battery for, for example, mobile devices, the thickness of active material layers of a positive electrode plate is about several micrometers to several tens of micrometers. In the case of using a relatively large-sized storage battery for power storage, the thickness thereof needs to be, for example, 50 μm or more per surface and 100 μm or more (preferably about 150 μm) for both surfaces. When the thickness of the active material layers is excessively large, the resistance of electrodes is increased or electrode plates are strained or wrinkled by the stress caused by expansion or contraction due to charge or discharge. Therefore, the thickness thereof is preferably 400 μm or less per surface and 800 μm or less (preferably 650 μm or less) for both surfaces. The configuration of the electrode plate according to this embodiment can be preferably used for electrode plates with a relatively large size (the thickness of active material layers is, for example, about 150 μm to 650 μm for both surfaces).

The coating weight of an active material varies depending on the thickness of an active material layer and the blend density of the active material. In order to maintain the permeability of an electrolyte solution to the active material layer to exhibit appropriate charge-discharge characteristics, the coating weight of the active material is preferably within an appropriate range.

The coating weight of a positive electrode active material is preferably 15 mg or more per square centimeter of a positive electrode per surface and 30 mg or more per square centimeter of the positive electrode for both surfaces. This is because when the coating weight of a positive electrode active material is less than 30 mg per square centimeter of the positive electrode for both surfaces, the percentage of the positive electrode active material in the positive electrode is small and therefore the density of energy is low.

When the positive electrode active material (effective active material), which contributes to charge-discharge capacity, is more than 76 mg per square centimeter of the positive electrode for both surfaces, a uniformly thick active material layer is often cracked or wrinkled during the manufacture of a positive electrode plate and the whole of the applied positive electrode active material cannot be sufficiently utilized; hence, it is difficult to manufacture a positive electrode plate with stable performance. From the above, the coating weight of the positive electrode active material is preferably about 30 mg/cm² to 76 mg/cm².

That is, the following plate can be obtained: a large-size positive electrode plate in which the thickness of positive electrode active material layers applied to both surfaces of a current collector is about 150 μm to 650 μm and the coating weight of a positive electrode active material (effective active material) is about 30 mg/cm² to 76 mg/cm² for both surfaces. A boundary section between a coated region and uncoated region of the positive electrode plate is provided with a buffer region (including at least one first buffer region C2). Therefore, failures such as the separation and cracking of the active material layers and the abrasion and cracking of the current collector are unlikely to occur, a two-plate pickup error during manufacture is improved, the initial failure rate is reduced, and the deterioration of load characteristics of a product can be suppressed.

As described above, according to this embodiment, an end portion of a coated region that extends to a boundary section between an uncoated region of an electrode plate is provided with a first buffer region C2 having a non-linear irregular shape in plan view; hence, a load is unlikely to be concentrated on the buffer region. Therefore, a load is not concentrated on the boundary section between the coated region and the uncoated region but is distributed. The electrode plate can be obtained such that even if applied active material layers are thick or the two-dimensional size of the electrode plate is large, failures such as the separation and cracking of the active material layers and the abrasion and cracking of a current collector are unlikely to occur.

In addition to the first buffer region C2, a second buffer region C3 in which the thickness of active material layers is gradually reduced from the coated region toward the uncoated region is provided, whereby a configuration in which a load is more unlikely to be concentrated is obtained. The separation and cracking of the active material layers, the abrasion and cracking of the current collector, and the like can be more effectively suppressed. Furthermore, a configuration in which the permeation of an electrolyte solution is likely to be promoted is obtained; hence, the impregnation rate of the electrolyte solution is increased.

A secondary battery, including the electrode plate having the above configuration, according to the present invention includes the electrode plate, in which failures such as the separation and cracking of the active material layers and the abrasion and cracking of the current collector are unlikely to occur. Therefore, the initial failure rate of the secondary battery can be reduced and load characteristics thereof can be enhanced. Even if external force such as vibration is applied to the secondary battery, the above failures are unlikely to occur. The secondary battery has increased safety in addition to quake resistance that no load characteristics are deteriorated.

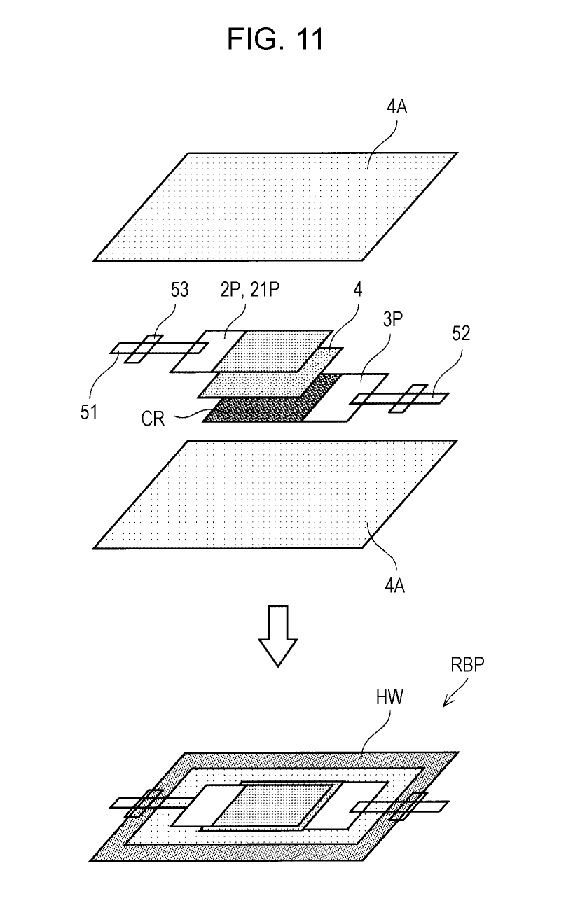

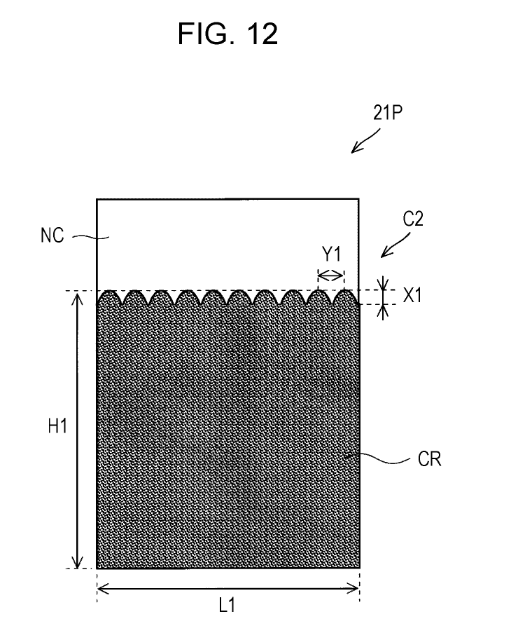

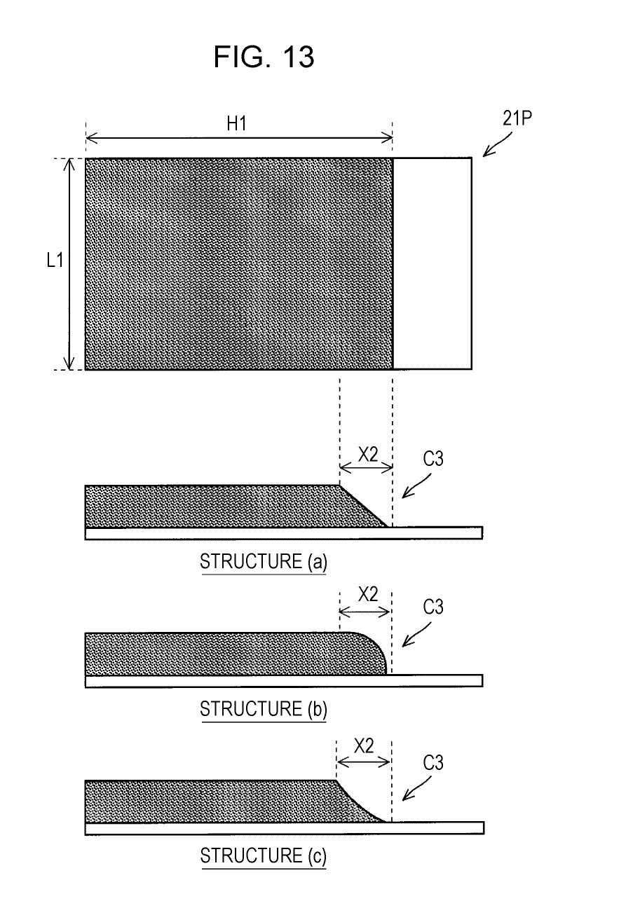

Examples 2 to 16 and Comparative Examples 2 to 18 in which a compact pack cell that is a laminate pack type of secondary battery was prepared are described below with reference to FIGS. 11 to 13 and Tables 2 to 4. FIG. 11 shows an exploded perspective view illustrating the configuration of a compact pack cell RBP according to this embodiment and a perspective view illustrating the whole appearance thereof. The view of the whole appearance is shown such that the inside can be seen through. FIG. 12 shows the region width X1 and interval Y1 of a first buffer region C2 placed on an electrode plate (positive electrode plate 21P) used in the compact pack cell RBP. FIG. 13 shows embodiments of Structure (a), Structure (b), and Structure (c) provided with a second buffer region C3 with a region width X2.

In the examples, each of positive electrode plates is provided with a first buffer region C2 and/or a second buffer region C3 and the effect of whether a buffer region is present is compared. That is, a positive electrode plate provided with any one of the buffer regions is represented by 21P and a positive electrode plate provided with no buffer region is represented by 2P. A negative electrode plate is provided with no buffer region and is represented by 3P. Herein, a positive electrode active material a used in Examples 2 to 16 and Comparative Examples 2 to 18 was synthesized by a method below.

[Synthesis of LiFe_{1 x}ZrₓP_{1 y}Si_{y}O₄]

For starting materials, LiCH₃COO was used as a lithium source, Fe(NO₃)₃. 9H₂O was used as an iron source, ZrCl₄ was used as a zirconium source, H₃PO₄ (85%) was used as a phosphorus source, and Si(OC₂H₅)₄ was used as a silicon source. The above materials were weighed such that LiCH₃COO, which was the lithium source, was 1.3196 g and the molar ratio of Li:Fe:Zr:P:Si was 1:0.974:0.026:0.974:0.026.

These were dissolved in 30 ml of C₂H₅OH, followed by stirring at room temperature for 48 hours using a stirrer. Thereafter, a solvent was removed in a 40° C. thermostatic bath, whereby dark brown powder was obtained. To the obtained powder, 15% by weight of sucrose was added, followed by mixing in an agate mortar and then press-forming pellets. These were fired at 500° C. for 12 hours in a nitrogen atmosphere, whereby single-phase powder was synthesized. The substitution amount x of Zr in an obtained positive electrode active material P was 0.025 and the substitution amount y of Si therein was 0.025. Lattice constants thereof were as follows: (a, b, c)=(10.330, 6.008, 4.694).

Next, they were weighed such that the molar ratio of Li:Fe:Zr:P:Si was 1:0.984:0.016:0.968:0.032. A positive electrode active material Q was prepared by the same method as the above. The substitution amount x of Zr in the obtained positive electrode active material Q was 0.015 and the substitution amount y of Si therein was 0.03. Lattice constants thereof were as follows: (a, b, c)=(10.326, 6.006, 4.685). They were weighed such that the molar ratio of Li:Fe:Zr:P:Si was 1:0.895:0.105:0.790:0.210. A positive electrode active material R was prepared by the same method as the above. The substitution amount x of Zr in the obtained positive electrode active material R was 0.1 and the substitution amount y of Si therein was 0.2. Lattice thereof constants were as follows: (a, b, c)=(10.337, 6.015, 4.720).

Furthermore, they were weighed such that the molar ratio of Li:Fe:Zr:P:Si was 1:1:0:1:0. A positive electrode active material S (LiFePO₄) was prepared by the same method as the above. Incidentally, the substitution amounts x and y are results obtained by a calibration curve method using an ICP mass spectrometer, ICP-MS7500cs, (manufactured by Agilent Technologies). The lattice constants were values determined by the above-mentioned procedure.

### [Preparation of Positive Electrode Plates]

The obtained positive electrode active material A (P, Q, R), acetylene black B, an acrylic resin C, and carboxymethylcellulose D were mixed at an A:B:C:D ratio of 100:3.5:5:1.2 on a weight percent basis, followed by stirring and mixing at room temperature using FILMIX 80-40 (manufactured by PRIMIX Corporation), whereby an aqueous electrode paste was obtained.

The electrode paste was applied to a surface of rolled aluminium foil (a thickness of 20 μm), followed by drying at 100° C. for 30 minutes in air. Thereafter, positive electrode plates 2P (coated surface size: 28 mm (length H1)×28 cm (width L1)) were obtained by pressing. Incidentally, the obtained positive electrode plates 2P had an average active material spread of 5 mg/cm² and an electrode density of 2.0 g/cm³.

[Preparation of Positive Electrode Plates Having First Buffer region]

The obtained positive electrode active material A, acetylene black B, the acrylic resin C, and carboxymethylcellulose D were mixed at an A:B:C:D ratio of 100:5:6:1.2 on a weight percent basis, followed by stirring and mixing at room temperature using FILMIX 80-40 (manufactured by PRIMIX Corporation), whereby an aqueous electrode paste was obtained. The electrode paste was applied to a surface of rolled aluminium foil (a thickness of 20 μm), followed by drying at 100° C. for 30 minutes in air. A coater was vibrated in directions perpendicular to a coating direction during application, whereby a first buffer region C2 having a region width X1 and an irregular shape designed to an irregular interval Y1 was provided between a power generation region CR coated with a predetermined amount of the active material and an uncoated region NC (refer to FIG. 12). Thereafter, positive electrode plates 21P (coated surface size: 28 mm (length H1)×28 cm (width L1)) were obtained by pressing. Incidentally, the obtained positive electrode plates 21P had an average active material spread of 5 mg/cm² and an electrode density of 2.0 g/cm³.

### [Preparation of Positive Electrode Plates Having Second Buffer Region]

The obtained positive electrode active material A, acetylene black B, the acrylic resin C, and carboxymethylcellulose D were mixed at an A:B:C:D ratio of 100:5:6:1.2 on a weight percent basis, followed by stirring and mixing at room temperature using FILMIX 80-40 (manufactured by PRIMIX Corporation), whereby an aqueous electrode paste was obtained. The electrode paste was applied to a surface of rolled aluminium foil (a thickness of 20 μm), followed by drying at 100° C. for 30 minutes in air. During application, a plurality of slurries with a solid concentration ranging from 35% to 55% were prepared and were applied in predetermined amounts, whereby electrodes each including a second buffer region C3 having a region width X2 and a slope were obtained, the second buffer region C3 being placed between a power generation region CR and an uncoated region NC (refer to FIG. 2). Furthermore, in the electrodes, slope structures of the second buffer regions C3 were categorized into three types: a linear type, a convex type, and a concave type, that is, Structure (a), Structure (b), and Structure (c), respectively. Thereafter, positive electrode plates 21P (coated surface size: 28 mm (length H1)×28 cm (width L1)) were obtained by pressing. Incidentally, the obtained positive electrode plates 21P had an average active material spread of 5 mg/cm² and an electrode density of 2.0 g/cm³.

### [Preparation of Negative Electrode Plates]

Natural graphite E, styrene-butadiene rubber F, and carboxymethylcellulose D were mixed at an E:F:D ratio of 98:2:1 on a weight percent basis, followed by stirring and mixing at room temperature using a twin-screw planetary mixer (manufactured by PRIMIX Corporation), whereby an aqueous electrode paste was obtained. The aqueous electrode paste was applied to a surface of rolled copper foil (a thickness of 10 μm) using a die coater, followed by drying at 100° C. for 30 minutes in air. N negative electrode plates 3P (coated surface size: 30 mm (corresponding to length H1)×30 cm (corresponding to width L1)) were obtained by pressing. Incidentally, the obtained negative electrode plates 3P had an average active material spread of 3 mg/cm² and an electrode density of 1.5 g/cm³.

### [Preparation of Batteries]

After the prepared positive electrode plates 2P and 21P and negative electrode plates 3P were vacuum-dried at 130° C. for 24 hours and were then put in a glove box in a dry Ar atmosphere, an aluminium tab lead 51 equipped with an adhesive film and a nickel tab lead 52 equipped with an adhesive film were ultrasonically welded to each of the positive electrode plates 2P and 21P and each of the negative electrode plates 3P, respectively. Subsequently, the positive and negative electrode plates were combined. In the glove box, a microporous polyolefin film (size: 30 mm (length)×30 cm (width), a thickness of 25 μm) as a separator 4 was stacked on each negative electrode plate 3P so as to cover the coated surface of the negative electrode plate 3P and each positive electrode plate (2P or 21P) was stacked thereon such that the coated surface was centered, whereby a unit cell was prepared.

Furthermore, the unit cell was interposed between aluminium laminate bags 4A and three sides of the aluminium laminate were heat-welded (a heat-welded portion HW) such that the adhesive film 53 of the tab lead was interposed therebetween. An electrolyte solution was introduced into the unit cell through an unwelded side, the electrolyte solution being prepared by dissolving 1 mol/L of LiPF₆ in a solvent prepared by mixing ethylene carbonate (EC) and diethyl carbonate (DEC) at a volume ratio of 1:2. The last one side was heat-welded at a reduced pressure of 10 kPa, whereby a battery (compact pack cell RBP) was obtained. The amount of the introduced electrolyte solution was determined depending on the thickness an electrode used in each battery such that electrolyte solution sufficiently permeated a positive electrode plate, negative electrode plate, and separator of an actually prepared battery.

Tables 2, 3, and 4 show specifications and experiment results of Examples 2 to 16 and Comparative Examples 2 to 18. Table 2 shows specifications and experiment results of Examples 2 to 6 and Comparative Examples 2 to 7 and 17. Table 3 shows specifications and experiment results of Examples 7 to 12 and Comparative Examples 2, 8 to 13, and 17. Table 4 shows specifications and experiment results of Examples 13 to 16 and Comparative Examples 2 and 14 to 18.

For Examples 2 to 16 and Comparative Examples 2 to 18 shown in Tables 2 to 4, the initial discharge capacity at 25° C. and the initial discharge capacity at 0° C. were measured. After these were subjected to a 3,500-cycle charge-discharge test in a 25° C. environment, the initial discharge capacity at 25° C. and the initial discharge capacity at 0° C. were measured again. The measurement results are shown in Tables 2 to 4.

Discharge capacity was capacity at 0.1 C-CC discharge (constant-current discharge: a cut voltage of 2.0 V) after 0.1 C-CCCV charge (constant-current constant-voltage charge: a cut voltage of 3.6 V, a cut current of 0.01 C) was performed. A charge-discharge cycle was performed at 1.0 C-CCCV charge (a cut voltage of 3.6 V, a cut current of 0.1 C) and 1.0 C-CC discharge (a cut voltage of 2.0 V). Incidentally, values in the tables are expressed in the form of proportions on the basis that the initial discharge capacity of each cell at 25° C. is 100.

Examples 2 to 6 provided with first buffer regions C2 and Comparative Examples 2 to 7 and 17 were summarized in Table 2. Comparative Examples 3 to 7 are examples provided with first buffer regions C2 and Comparative Examples 2 and 17 are examples provided with no buffer region. From the results, it was confirmed that in the case where LiFe_{1 x}ZrₓP_{1 y}Si_{y}O₄ was used for an active material and a positive electrode plate was provided with a first buffer region C2, the capacity at 25° C. and the capacity at 0° C. after cycles were increased regardless of the size thereof.

Examples 7 to 12 provided with second buffer regions C3 and Comparative Examples 2, 8 to 13, and 17 were summarized in Table 3. Comparative Examples 8 to 13 are examples provided with second buffer regions C3 and Comparative Examples 2 and 17 are examples provided with no buffer region. From the results, it was confirmed that in the case where LiFe₁₋ₓZrₓP_{1-y}Si_{y}O₄ was used for an active material and a positive electrode plate was provided with a second buffer region C3, the capacity at 25° C. and the capacity at 0° C. after cycles were increased regardless of the size and structure thereof.

Examples 13 to 16 provided with both first buffer regions C2 and second buffer regions C3 and Comparative Examples 2 and 14 to 18 were summarized in Table 4. Comparative Examples 14 to 16 and 18 are examples provided with both buffer regions and Comparative Examples 2 and 17 are examples provided with no buffer region. From the results, a synergistic effect obtained by providing both the buffer regions was confirmed.

From Example 16, when a composition is LiFe₁₋ₓ ZrₓP_{1-y}Si_{y}O₄ and lattice constants are within a predetermined range (10.326≦a≦10.335, 6.006≦b≦6.012, 4.685≦c≦4.714) like the positive electrode active material Q, a sufficient effect is obtained. However, from Comparative Example 18, in the case of using the positive electrode active material R, which has lattice constants that are outside the range, even though a composition is LiFe₁₋ₓZrₓP_{1-y}Si_{y}O₄, no sufficient effect is obtained.

The above effects are probably due to the fact that an active material with low volume expansion and contraction is used, the separation of an electrode due to expansion or contraction during a cycle is prevented by devising the structure of an uncoated region, and the increase in resistance of an electrode is suppressed.

TABLE 2

| | | | | | | | | | | | Initial | | Capacity after | |
|---|---|---|---|---|---|---|---|---|---|---|---|---|---|---|
| | | | | | Buffer regions | | | | | | capacity | | 3,500 cycles | |
| | | | | | | | | | | Cross- | Room | Low | Room | Low |
| | Positive electrode | Lattice | | | | | | | | sec- | temper- | temper- | temper- | temper- |
| | active material | constants | | | | Sec- | | | | tional | ature | ature | ature | ature |
| | (Composition) | a | b | c | First | ond | X1 | Y1 | X2 | shape | (25° C.) | (0° C.) | (25° C.) | (0° C.) |
| Exam- | Positive electrode | 10.330 | 6.008 | 4.694 | ◯ | — | 1 mm | 2 mm | — | — | 100 | 82.9 | 94.5 | 70.5 |
| ple 2 | active material P | | | | | | | | | | | | | |
| | (LiFe₁₋ₓZrₓP_{1-y}Si_{y}O₄) | | | | | | | | | | | | | |
| Exam- | Positive electrode | 10.330 | 6.008 | 4.694 | ◯ | — | 1 mm | 5 mm | — | — | 100 | 83.1 | 94.3 | 69.8 |
| ple 3 | active material P | | | | | | | | | | | | | |
| | (LiFe₁₋ₓZrₓP_{1-y}Si_{y}O₄) | | | | | | | | | | | | | |
| Exam- | Positive electrode | 10.330 | 6.008 | 4.694 | ◯ | — | 1 mm | 10 mm | — | — | 100 | 82.5 | 94.7 | 71.0 |
| ple 4 | active material P | | | | | | | | | | | | | |
| | (LiFe₁₋ₓZrₓP_{1-y}Si_{y}O₄) | | | | | | | | | | | | | |
| Exam- | Positive electrode | 10.330 | 6.008 | 4.694 | ◯ | — | 5 mm | 5 mm | — | — | 100 | 84.1 | 95.3 | 70.6 |
| ple 5 | active material P | | | | | | | | | | | | | |
| | (LiFe₁₋ₓZrₓP_{1-y}Si_{y}O₄) | | | | | | | | | | | | | |
| Exam- | Positive electrode | 10.330 | 6.008 | 4.694 | ◯ | — | 5 mm | 10 mm | — | — | 100 | 83.5 | 94.9 | 70.1 |
| ple 6 | active material P | | | | | | | | | | | | | |
| | (LiFe₁₋ₓZrₓP_{1-y}Si_{y}O₄) | | | | | | | | | | | | | |
| Compar- | Positive electrode | 10.330 | 6.008 | 4.694 | — | — | — | — | 0.1 mm | — | 100 | 78.0 | 92.1 | 54.6 |
| ative | active material P | | | | | | | | | | | | | |
| Exam- | (LiFe₁₋ₓZrₓP_{1-y}Si_{y}O₄) | | | | | | | | | | | | | |
| ple 2 | | | | | | | | | | | | | | |
| Compar- | Positive electrode | — | — | — | ◯ | — | 1 mm | 2 mm | — | — | 100 | 79.8 | 82.4 | 59.9 |
| ative | active material S | | | | | | | | | | | | | |
| Exam- | (LiFePO₄) | | | | | | | | | | | | | |
| ple 3 | | | | | | | | | | | | | | |
| Compar- | Positive electrode | — | — | — | ◯ | — | 1 mm | 5 mm | — | — | 100 | 80.1 | 82.7 | 59.3 |
| ative | active material S | | | | | | | | | | | | | |
| Exam- | (LiFePO₄) | | | | | | | | | | | | | |
| ple 4 | | | | | | | | | | | | | | |
| Compar- | Positive electrode | — | — | — | ◯ | — | 1 mm | 10 mm | — | — | 100 | 79.6 | 82.1 | 60.5 |
| ative | active material S | | | | | | | | | | | | | |
| Exam | (LiFePO₄) | | | | | | | | | | | | | |
| ple 5 | | | | | | | | | | | | | | |
| Compar- | Positive electrode | — | — | — | ◯ | — | 5 mm | 5 mm | — | — | 100 | 81.0 | 83.1 | 59.9 |
| ative | active material S | | | | | | | | | | | | | |
| Exam- | (LiFePO₄) | | | | | | | | | | | | | |
| ple 6 | | | | | | | | | | | | | | |
| Compar- | Positive electrode | — | — | — | ◯ | — | 5 mm | 10 mm | — | — | 100 | 80.6 | 82.2 | 59.6 |
| ative | active material S | | | | | | | | | | | | | |
| Exam- | (LiFePO₄) | | | | | | | | | | | | | |
| ple 7 | | | | | | | | | | | | | | |
| Compar- | Positive electrode | — | — | — | — | — | — | — | 0.1 mm | — | 100 | 74.0 | 80.2 | 44.4 |
| ative | active material S | | | | | | | | | | | | | |
| Exam- | (LiFePO₄) | | | | | | | | | | | | | |
| ple 17 | | | | | | | | | | | | | | |

TABLE 3

| | | | | | | | | | | | Initial | | Capacity after | |
|---|---|---|---|---|---|---|---|---|---|---|---|---|---|---|
| | | | | | Buffer regions | | | | | | capacity | | 3,500 cycles | |
| | | | | | | | | | | Cross- | Room | Low | Room | Low |
| | Positive electrode | Lattice | | | | | | | | sec- | temper- | temper- | temper- | temper- |
| | active material | constants | | | | Sec- | | | | tional | ature | ature | ature | ature |
| | (Composition) | a | b | c | First | ond | X1 | Y1 | X2 | shape | (25° C.) | (0° C.) | (25° C.) | (0° C.) |
| Exam- | Positive electrode | 10.330 | 6.008 | 4.694 | — | ◯ | — | — | 1 mm | Struc- | 100 | 82.8 | 94.7 | 67.9 |
| ple 7 | active material P | | | | | | | | | ture (a) | | | | |
| | (LiFe₁₋ₓZrₓP_{1-y}Si_{y}O₄) | | | | | | | | | | | | | |
| Exam- | Positive electrode | 10.330 | 6.008 | 4.694 | — | ◯ | — | — | 1 mm | Struc- | 100 | 83.0 | 94.4 | 67.2 |
| ple 8 | active material P | | | | | | | | | ture (b) | | | | |
| | (LiFe₁₋ₓZrₓP_{1-y}Si_{y}O₄) | | | | | | | | | | | | | |
| Exam- | Positive electrode | 10.330 | 6.008 | 4.694 | — | ◯ | — | — | 1 mm | Struc- | 100 | 82.5 | 95.1 | 66.0 |
| ple 9 | active material P | | | | | | | | | ture (c) | | | | |
| | (LiFe₁₋ₓZrₓP_{1-y}Si_{y}O₄) | | | | | | | | | | | | | |
| Exam- | Positive electrode | 10.330 | 6.008 | 4.694 | — | ◯ | — | — | 5 mm | Struc- | 100 | 82.5 | 94.8 | 65.2 |
| ple 10 | active material P | | | | | | | | | ture (a) | | | | |
| | (LiFe₁₋ₓZrₓP_{1-y}Si_{y}O₄) | | | | | | | | | | | | | |
| Exam- | Positive electrode | 10.330 | 6.008 | 4.694 | — | ◯ | — | — | 5 mm | Struc- | 100 | 83.1 | 95.1 | 66.5 |
| ple 11 | active material P | | | | | | | | | ture (b) | | | | |
| | (LiFe₁₋ₓZrₓP_{1-y}Si_{y}O₄) | | | | | | | | | | | | | |
| Exam- | Positive electrode | 10.330 | 6.008 | 4.694 | — | ◯ | — | — | 5 mm | Struc- | 100 | 82.7 | 94.6 | 67.0 |
| ple 12 | active material P | | | | | | | | | ture (c) | | | | |
| | (LiFe₁₋ₓZrₓP_{1-y}Si_{y}O₄) | | | | | | | | | | | | | |
| Compar- | Positive electrode | 10.330 | 6.008 | 4.694 | — | — | — | — | 0.1 mm | — | 100 | 78.0 | 92.1 | 54.6 |
| ative | active material P | | | | | | | | | | | | | |
| Exam- | (LiFe₁₋ₓZrₓP_{1-y}Si_{y}O₄) | | | | | | | | | | | | | |
| ple 2 | | | | | | | | | | | | | | |
| Compar- | Positive electrode | — | — | — | — | ◯ | — | — | 1 mm | Struc- | 100 | 79.5 | 81.5 | 57.2 |
| ative | active material S | | | | | | | | | ture (a) | | | | |
| Exam- | (LiFePO₄) | | | | | | | | | | | | | |
| ple 8 | | | | | | | | | | | | | | |
| Compar- | Positive electrode | — | — | — | — | ◯ | — | — | 1 mm | Struc- | 100 | 80.1 | 81.7 | 56.9 |
| ative | active material S | | | | | | | | | ture (b) | | | | |
| Exam- | (LiFePO₄) | | | | | | | | | | | | | |
| ple 9 | | | | | | | | | | | | | | |
| Compar- | Positive electrode | — | — | — | — | ◯ | — | — | 1 mm | Struc- | 100 | 79.9 | 81.4 | 55.9 |
| ative | active material S | | | | | | | | | ture (c) | | | | |
| Exam- | (LiFePO₄) | | | | | | | | | | | | | |
| ple 10 | | | | | | | | | | | | | | |
| Compar- | Positive electrode | — | — | — | — | ◯ | — | — | 5 mm | Struc- | 100 | 78.9 | 81.0 | 54.4 |
| ative | active material S | | | | | | | | | ture (a) | | | | |
| Exam- | (LiFePO₄) | | | | | | | | | | | | | |
| ple 11 | | | | | | | | | | | | | | |
| Compar- | Positive electrode | — | — | — | — | ◯ | — | — | 5 mm | Struc- | 100 | 79.8 | 81.2 | 55.9 |
| ative | active material S | | | | | | | | | ture (b) | | | | |
| Exam- | (LiFePO₄) | | | | | | | | | | | | | |
| ple 12 | | | | | | | | | | | | | | |
| Compar- | Positive electrode | — | — | — | — | ◯ | — | — | 5 mm | Struc- | 100 | 79.4 | 80.9 | 56.4 |
| ative | active material S | | | | | | | | | ture (c) | | | | |
| Exam- | (LiFePO₄) | | | | | | | | | | | | | |
| ple 13 | | | | | | | | | | | | | | |
| Compar- | Positive electrode | — | — | — | — | — | — | — | 0.1 mm | — | 100 | 74.0 | 80.2 | 44.4 |
| ative | active material S | | | | | | | | | | | | | |
| Exam- | (LiFePO₄) | | | | | | | | | | | | | |
| ple 17 | | | | | | | | | | | | | | |

TABLE 4

| | | | | | | | | | | | Initial | | Capacity after | |
|---|---|---|---|---|---|---|---|---|---|---|---|---|---|---|
| | | | | | Buffer regions | | | | | | capacity | | 3,500 cycles | |
| | | | | | | | | | | Cross- | Room | Low | Room | Low |
| | Positive electrode | Lattice | | | | | | | | sec- | temper- | temper- | temper- | temper- |
| | active material | constants | | | | Sec- | | | | tional | ature | ature | ature | ature |
| | (Composition) | a | b | c | First | ond | X1 | Y1 | X2 | shape | (25° C.) | (0° C.) | (25° C.) | (0° C.) |
| Exam- | Positive electrode | 10.330 | 6.008 | 4.694 | ◯ | ◯ | 5 mm | 5 mm | 5 mm | Struc- | 100 | 85.8 | 98.0 | 72.9 |
| ple 13 | active material P | | | | | | | | | ture (a) | | | | |
| | (LiFe₁₋ₓZrₓP_{1-y}Si_{y}O₄) | | | | | | | | | | | | | |
| Exam- | Positive electrode | 10.330 | 6.008 | 4.694 | ◯ | ◯ | 5 mm | 5 mm | 5 mm | Struc- | 100 | 86.0 | 97.5 | 74.8 |
| ple 14 | active material P | | | | | | | | | ture (b) | | | | |
| | (LiFe₁₋ₓZrₓP_{1-y}Si_{y}O₄) | | | | | | | | | | | | | |
| Exam- | Positive electrode | 10.330 | 6.008 | 4.694 | ◯ | ◯ | 5 mm | 5 mm | 5 mm | Struc- | 100 | 85.5 | 97.7 | 73.5 |
| ple 15 | active material P | | | | | | | | | ture (c) | | | | |
| | (LiFe₁₋ₓZrₓP_{1-y}Si_{y}O₄) | | | | | | | | | | | | | |
| Exam- | Positive electrode | 10.326 | 6.006 | 4.685 | ◯ | ◯ | 5 mm | 5 mm | 5 mm | Struc- | 100 | 85.2 | 97.0 | 72.4 |
| ple 16 | active material Q | | | | | | | | | ture (a) | | | | |
| | (LiFe₁₋ₓZrₓP_{1-y}Si_{y}O₄) | | | | | | | | | | | | | |
| Compar- | Positive electrode | 10.330 | 6.008 | 4.694 | — | — | — | — | 0.1 mm | — | 100 | 78.0 | 92.1 | 54.6 |
| ative | active material P | | | | | | | | | | | | | |
| Exam- | (LiFe₁₋ₓZrₓP_{1-y}Si_{y}O₄) | | | | | | | | | | | | | |
| ple 2 | | | | | | | | | | | | | | |
| Compar- | Positive electrode | — | — | — | ◯ | ◯ | 5 mm | 5 mm | 5 mm | Struc- | 100 | 82.1 | 87.2 | 61.6 |
| ative | active material S | | | | | | | | | ture (a) | | | | |
| Exam- | (LiFePO₄) | | | | | | | | | | | | | |
| ple 14 | | | | | | | | | | | | | | |
| Compar- | Positive electrode | — | — | — | ◯ | ◯ | 5 mm | 5 mm | 5 mm | Struc- | 100 | 82.9 | 87.5 | 63.8 |
| ative | active material S | | | | | | | | | ture (b) | | | | |
| Exam- | (LiFePO₄) | | | | | | | | | | | | | |
| ple 15 | | | | | | | | | | | | | | |
| Compar- | Positive electrode | — | — | — | ◯ | ◯ | 5 mm | 5 mm | 5 mm | Struc- | 100 | 82.5 | 86.5 | 62.7 |
| ative | active material S | | | | | | | | | ture (c) | | | | |
| Exam- | (LiFePO₄) | | | | | | | | | | | | | |
| ple 16 | | | | | | | | | | | | | | |
| Compar- | Positive electrode | — | — | — | — | — | — | — | 0.1 mm | — | 100 | 74.0 | 80.2 | 44.4 |
| ative | active material S | | | | | | | | | | | | | |
| Exam- | (LiFePO₄) | | | | | | | | | | | | | |
| ple 17 | | | | | | | | | | | | | | |
| Compar- | Positive electrode | 10.337 | 6.015 | 4.720 | ◯ | ◯ | 5 mm | 5 mm | 5 mm | Struc- | 100 | 83.0 | 89.0 | 64.2 |
| ative | active material R | | | | | | | | | ture (a) | | | | |
| Exam- | (LiFe₁₋ₓZrₓP_{1-y}Si_{y}O₄) | | | | | | | | | | | | | |
| ple 18 | | | | | | | | | | | | | | |

### INDUSTRIAL APPLICABILITY

Therefore, an electrode plate and secondary battery according to the present invention are preferably applicable to a stack type of high-capacity storage battery in which the upsizing of an electrode plate and the stabilization of battery performance are required.

### REFERENCE SIGNS LIST

1 Electrode group

2 Positive electrode plate

3 Negative electrode plate

4 Separator

5 Current collector terminal

10 Battery can

11 Cover case

12 Lid member

20 Metal foil

21 Electrode plate

23 Boundary section

23A Wavy irregular shape

23B Angular irregular shape

C1 Power generation region

C2 First buffer region

C3 Second buffer region

CR Coated region

NC Uncoated region

RB Secondary battery

RBP Compact pack cell

1. An electrode plate including a current collector and an active material layer formed on the current collector, comprising:
a coated region where the active material layer is formed and an uncoated region where no active material layer is formed, wherein an end portion of the coated region that extends to a boundary section between the uncoated region is provided with a first buffer region having a non-linear irregular shape in plan view; and
a second buffer region in which the thickness of the active material layer is gradually reduced from the coated region toward the uncoated region.

2. (canceled)

3. The electrode plate according to claim 1, wherein the electrode plate is a positive electrode plate, the active material layer is formed on both surfaces of the current collector, and, in the coated region having the uniformly thick active material layer, the coating weight of an active material contained in the active material layer is 30 mg/cm² to 76 mg/cm² for both surfaces.

4. The electrode plate according to claim 1, wherein the electrode plate is a positive electrode plate, the active material layer is formed on both surfaces of the current collector, and the thickness of the active material layer in the coated region having the uniformly thick active material layer is 150 μm to 650 μm for both surfaces.

5. The electrode plate according to claim 1, wherein the electrode plate includes positive and negative electrode plates, coated regions having active material layers are placed opposite to each other with separators interposed therebetween to form power generation regions, the power generation regions of the positive electrode plates are placed inside the coated regions of the negative electrode plates that have the uniformly thick active material layers, and the buffer regions of the negative electrode plates are placed outside the coated regions of the positive electrode plates that have the uniformly thick active material layers.

6. A secondary battery comprising positive electrode plates each including a current collector and an active material layer formed thereon, negative electrode plates each including a current collector and an active material layer formed thereon, and current collector members electrically connected to the electrode plates, wherein at least one of the positive electrode plates and the negative electrode plates is the electrode plate according to claim 1 and the current collector members are welded to the current collectors in the uncoated region.

7. The electrode plate according to claim 1, wherein
the electrode plate is a positive electrode plate,
the active material layer is formed on both surfaces of the current collector,
in the coated region having the uniformly thick active material layer, the coating weight of an active material contained in the active material layer is 30 mg/cm² to 76 mg/cm² for both surfaces, and
the thickness of the active material layer in the coated region having the uniformly thick active material layer is 150 μm to 650 μm for both surfaces

8. The electrode plate according to claim 1, wherein
the electrode plate includes positive and negative electrode plates,
coated regions having active material layers are placed opposite to each other with separators interposed therebetween to form power generation regions,
the power generation regions of the positive electrode plates are placed inside the coated regions of the negative electrode plates that have the uniformly thick active material layers, the buffer regions of the negative electrode plates are placed outside the coated regions of the positive electrode plates that have the uniformly thick active material layers, and
current collector members electrically connected to the electrode plates are provided which are welded to the current collectors in the uncoated region.
